(19) United States
(12) Patent Application Publication
(10) Pub. No.: US 2013/0194809 A1
(43) Pub. Date: Aug. 1, 2013

(54) LIGHTING ASSEMBLY WITH CORNUATE LIGHT GUIDE

(71) Applicants: Brian E. Richardson, Los Gatos, CA (US); Timothy A. McCollum, Avon Lake, OH (US); Fumitomo Hide, San Jose, CA (US); Gregg M. Podojil, Brecksville, OH (US)

(72) Inventors: Brian E. Richardson, Los Gatos, CA (US); Timothy A. McCollum, Avon Lake, OH (US); Fumitomo Hide, San Jose, CA (US); Gregg M. Podojil, Brecksville, OH (US)

(73) Assignee: RAMBUS DELAWARE LLC, Brecksville, OH (US)

(21) Appl. No.: 13/878,485

(22) PCT Filed: Oct. 21, 2011
(86) PCT No.: PCT/US11/57356

§ 371 Date: Apr. 9, 2013

Related U.S. Application Data
(60) Provisional application No. 61/455,537, filed on Oct. 21, 2010.

(51) Int. Cl. F21V 7/00

(52) U.S. Cl. CPC F21V 7/0033
USPC 362/298

(57) ABSTRACT

A lighting assembly that includes a cornuate light guide and an annular light extracting and redirecting member. The light guide has a radial light input surface, an axial light input region, radial light output region and a flared region between input region and output region. Light input at the light input surface propagates to and within the light output region by total internal reflection at major surfaces of the light guide. The light extracting and redirecting member has a light extracting element in optical contact with an annular region of one of the major surfaces of the light output region, and a reflective light redirecting element to axially redirect the extracted light with a defined light ray angle distribution.

### BACKGROUND

Recent improvements in the performance of LEDs, coupled with a concurrent reduction in the cost of production, have made LEDs a more viable light source for many applications. However, some applications, such as sign lighting, overhead lighting, flashlights, spot lights, search lights, and automotive lighting, require the concentrated light that is generated by an LED to be controlled in direction and beam angle. These applications require an improved optical system to provide the desired light control.

### BRIEF DESCRIPTION OF THE DRAWINGS

FIG. 1 is a perspective view of the backside of an embodiment of a lighting assembly having a cornuate light guide.

FIG. 2 is a cross-sectional view of the lighting assembly shown in FIG. 1 taken along the section line 2-2.

FIG. 3 is a side view showing the light input region of the light guide of e lighting assembly shown in FIGS. 1 and 2.

FIG. 4 is an enlarged cross-sectional view showing part of the light output region of the light guide and two light extracting and redirecting members of the lighting assembly shown in FIGS. 1 and 2.

FIG. 5 is an enlarged cross-sectional view showing part of the light output region of the light guide and two light extracting and redirecting members of another embodiment of a lighting assembly.

FIG. 6 is an enlarged cross-sectional view showing part of the light output region of the light guide and three light extracting and redirecting members of yet another embodiment of a lighting assembly.

FIG. 7 is a cross-sectional view of another embodiment of a lighting assembly shown.

### DETAILED DESCRIPTION

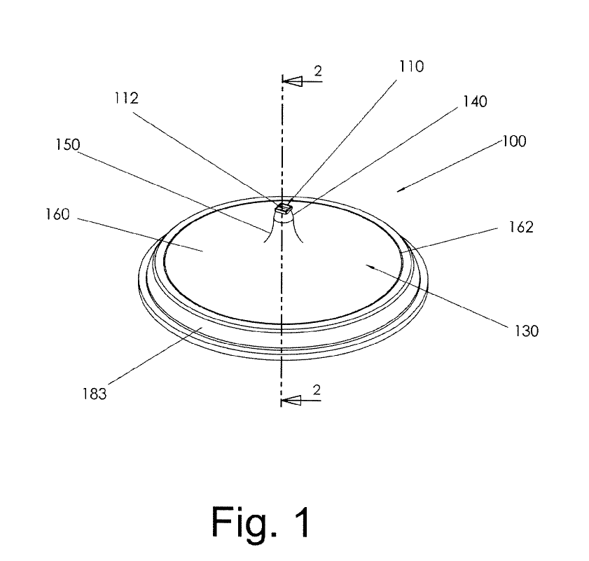

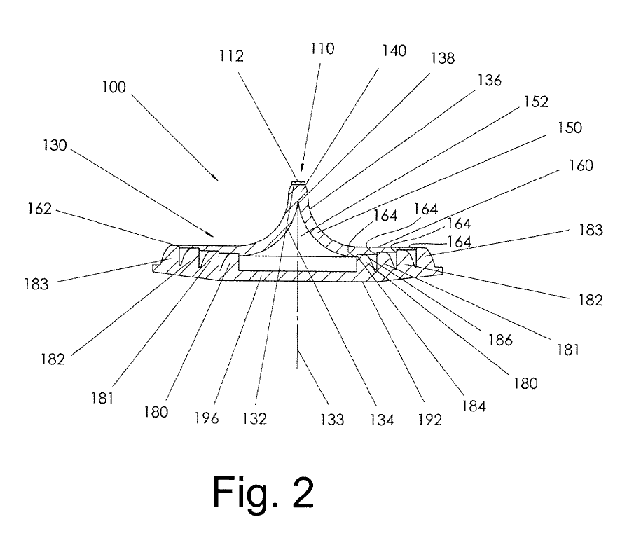

FIG. 1 is a perspective view and FIG. 2 is a cross-sectional view showing an example of a lighting apparatus 100 having a light source 110, a cornuate light guide 130, and an annular light extracting and redirecting member 180. Light guide 130 has a radial light input surface 132 adjacent light source 110, a light input region 140 that extends axially from light input surface 132, a radial light output region 160 having an outer edge 162, and a flared region 150 connecting light input region 140 to light output region 160.

Light guide 130 has an inner major surface 134 and an outer major surface 136. Light from light source 110 input to light guide 130 through light input surface 132 propagates to and within the light output region 160 of the light guide by total internal reflection at major surfaces 134, 136.

Annular light extracting and redirecting member 180 includes an annular light extracting element 184 in optical contact with a respective annular region of one of the major surfaces 134, 136 of the light output region 160 of the light guide. Light extracting and redirecting member 180 additionally includes an annular reflective light redirecting element 186 to axially redirect the light extracted from the light output region 160 of the light guide by light extracting element 184 with a defined light ray angle distribution. As used in this disclosure, the term light my angle distribution describes the variation of the intensity of output light with angle. In the example shown, lighting assembly 100 has four concentric annular light extracting and redirecting members 180, 181, 182, 183 that are radially offset from one another. Other examples have more or fewer light extracting and redirecting members than the example shown.

Examples of light source 110 include solid-state light emitters such as LEDs (light emitting diodes), laser diodes, and organic LEDs (OLEDs). In an embodiment where the light source 110 is an LED, the LED may be a top-fire LED or a side-fire LED, and may be a broad-spectrum LED (e.g., emit white light) or an LED that emits light of a desired color or spectrum (e.g., red light, green light, blue light, or ultraviolet light) In one embodiment, light source 110 emits light with no operably-effective intensity at wavelengths greater than 500 nanometers (nm i.e., the light source emits light at wavelengths that are predominantly less than 500 nm. In such an embodiment, a phosphor (not shown) converts at least part of the light emitted by light source 110 to longer wavelength light.

In other examples, light source 110 includes more than one solid-state light emitter located adjacent the light input surface 132 of light guide 130. In this case, the solid-state light emitters would be smaller than the exemplary solid-state light emitter 112 shown in FIG. 2. Alternatively, light input surface 132 and light input region 140 could be increased in radial size compared with the example shown to accommodate more than a single solid-state light emitter. Alternatively, the solid-state light emitters constituting light source 110 are mounted remotely from light guide 130 and a respective light guide (not shown) is used to convey the light output from each solid-state light emitter to light input surface 132. In this arrangement, the proximal end of the light guide may be in optical contact with the solid-state light emitter and the distal end of the light guide is in optical contact with (or is integral with) light input surface 132. Light source 110 typically additionally includes a printed circuit board (not shown), on which the one or more solid-state light emitters are mounted, and a heat sink. The printed circuit board is typically heat conducting.

In an example, each solid-state light emitter 112 generates light of a respective color, such as red light, green light, yellow light, cyan light or blue light. In another example, the solid-state light emitters are a mixture of broad-spectrum LEDs and LEDs that emit monochromatic light of a desired color. In examples in which light source 110 includes more than one solid-state light emitter, the length of the light input region 140 of light guide 130 may be increased relative to that illustrated to allow light from the solid-state light emitters to mix before the light enters the flared region 150 of the light guide.

In embodiments in which light source 110 is composed of LEDs that generate respective colors of light, the intensity of the light generated by the LEDs can be controlled to define the color of the light output by lighting assembly 100. Moreover, one or more sensors can be located on light guide 130 to monitor the spectrum of the light propagating within the light guide. For example, a sensor can be attached to the inner major surface 134 of the light guide facing light source 110. One exemplary location for the sensor is where the inner major surface defines an apex 138. By controlling the current driving the solid-state light emitters generating the light of different colors in response to the output of the sensor(s), the color of the light output by the lighting apparatus can be maintained notwithstanding variations in power-line voltage, ambient conditions, and other variables, and differing aging properties of the solid-state light emitters that generate the light of different colors. Moreover, the desired color of the light to be output by lighting assembly 100 can be defined by a control signal in accordance with one or more industry-standard protocols. DMX512 is an example of protocol commonly used to control lighting assemblies.

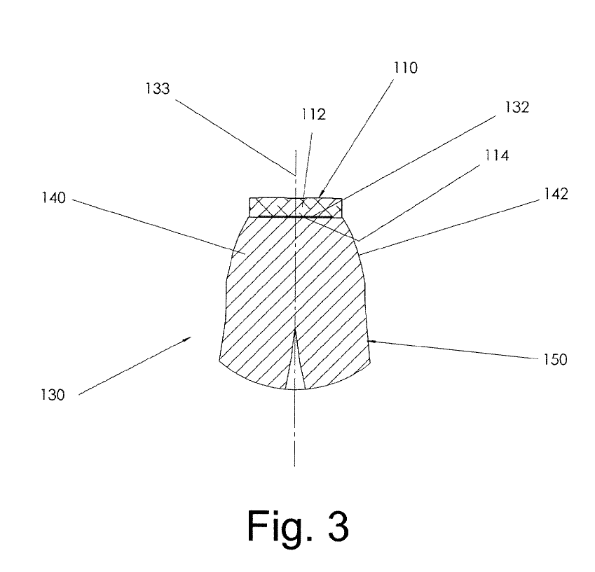

FIG. 3 is an enlarged view showing light source 110 and the light input region 140 of cornuate light guide 130. A normal to the center of the light input surface 132 of light guide 130 defines a longitudinal axis 133. A direction parallel to axis 133 is referred to herein as an axial direction and a direction orthogonal to axis 133 is referred to herein as a radial direction. In the example shown, the solid-state light emitter 112 constituting light source 100 is mounted at the center of light input surface 132. Light input region 140 extends axially from light input surface 132.

The light input surface 132 of light guide 130 is described above as adjacent light source 110. However, a significant increase in the efficiency with which light is coupled from light source 110 to light guide 130 and, hence in the overall efficiency of lighting assembly 100, is obtained by mounting the solid-state light emitter 112 that constitutes at least part of light source 110 in optical contact with light input surface 132. Solid-state light emitter 112 has a light exit surface 114 in optical contact with light input surface 132. Optically coupling solid-state light emitter 112 to light input surface 132 allows more of the light generated by the solid-state light emitter to couple into the light guide than if the solid-state light emitter were separated from the light input surface by an air gap. The fraction of the light generated by the solid-state light emitter coupled into the light guide is a function of the angle of incidence of the light generated by the solid-state light emitter on the exit surface 114 of solid-state light emitter 112 and the ratio between the refractive index Na of the material adjacent exit surface 114 external to the solid-state light emitter and the refractive index NI of the material adjacent exit surface 114 internal to the solid-state light emitter. In this disclosure, angles of incidence, angles of reflection and angles of refraction are measured relative to the normal to the surface. Specifically, the angle of incidence θ₁ of the light generated by solid-state light emitter 112 on exit surface 114 at which the light can exit the solid-state light emitter instead of being reflected back into the solid-state light emitter is within the range given by:

θ₁=±arcsine (Na/NI)

A typical solid-state light emitter 112 that generates white light includes an LED (not shown) that generates blue light encapsulated by an encapsulant having phosphor particles embedded in binder, typically an epoxy binder. The exit surface 114 of the solid-state light emitter is a surface of the encapsulant, which typically has a refractive index NI=1.5. In an embodiment in which the exit surface 114 of solid-state light emitter 112 is separated from light input surface 132 by an air gap, the material adjacent exit surface 114 external to the solid-state light emitter is air that has a refractive index Na=1. In this case, the angle of incidence on the exit surface at which the light can exit the solid-state light emitter is within the range of ±42° (arcsine (1/1.5)) to the exit surface. Thus, of the light generated by solid-state light emitter 112, only the portion thereof incident on exit surface 114 at an angle of incidence within the range of ±42° to the exit surface can exit the solid-state light emitter through the exit surface. Moreover, Fresnel reflective losses increase with increasing angle of incidence on the exit surface within the above-described range of angles of incidence.

Light that is reflected by exit surface 114 back into the solid-state light emitter by total internal reflection (TIR) or by Fresnel reflection is at least partially absorbed by the solid-state light emitter and is therefore lost.

The light that exits solid-state light emitter 112 into the air gap is refracted at exit surface 114 at angles of refraction that range from about +90° to about −90°. Some of the light output from the solid-state light emitter fails to enter the light guide, either because the light is not incident on the light input surface, or the light is incident on light input surface 132 at a large angle of incidence, which causes a significant Fresnel reflection loss. The remainder of the light output from solid-state light emitter 112 enters light guide 130 through light input surface 132.

an embodiment in which the exit. surface 114 of solid-state light emitter 112 is in optical contact with the light input surface 132 of light guide 130, the material adjacent exit surface 114 internal to the solid-state light emitter has a refractive index NI=1.5 as before, but the material adjacent exit surface 114 external to the solid-state light emitter has a refractive index NI=1.59 in an example in which the material of light guide 130 is polycarbonate, or 1.49 in an example in which the material of light guide 130 is acrylic. A coupling material (not shown) is used to provide optical coupling between the exit surface 114 of solid-state light emitter 112 and the light input surface 132 of light guide 130. In an example, an optical adhesive is used to affix exit surface 114 to light input surface 132. In another example, a silicone coupling material is used. The coupling material should have a refractive index close to those of the materials of exit surface 114 and light input surface 132 to increase coupling efficiency.

With the exit surface 114 of solid-state light emitter 112 in optical contact with the light input surface 132 of light guide 130, the range of angles of incidence on light exit surface 114 at which the light can exit the solid-state light emitter is increased to almost ±90° and losses due to Fresnel reflection are reduced. Consequently, a substantially larger fraction of the light generated by the solid-state light emitter is coupled from the solid-state light emitter to the light guide.

Referring again to FIGS. 1 and 2, light guide 130 is referred to herein as a cornuate light guide to denote its generally horn-shaped configuration. The light guide is horn-shaped more in the sense of the shape of the bell of a brass musical instrument, such as a trumpet, than an animal horn. Cornuate light guide 130 is a solid article made from, for example, acrylic, polycarbonate, glass, or another appropriate material. Light guide 130 has three regions, namely, light input region 140, light output region 160 and light coupling region 150 that couples light output region 160 to light input region 140. Light input region 140 extends axially, i.e., along longitudinal axis 133, from light input surface 132 and is generally cylindrical in shape. Light output region 160 is generally planar, is annular in shape and extends radially outwards relative to axis 133 to outer edge 162.

Coupling region 150 flares outward with increasing axial distance from light input surface 132. Adjacent light input region 140, the coupling region extends predominantly axially. Adjacent light output region 160, the coupling region extends predominantly radially. Between the light input region and the light output region, the axial. extension of the coupling region progressively decreases and the radial extension progressively increases to smoothly couple the substantially radial light output region to the substantially axial light input region. The inner major surface 134 of light guide 130 has corresponding portions at least in coupling region 150 and light output region 160. The outer major surface 136 of light guide 130 has corresponding portions in light input region 140, coupling region 150 and light output region 160.

FIG. 3 is an enlarged cross-sectional view showing in greater detail the light input region 140 and a proximal portion of the coupling region 150 of cornuate light guide 130. As noted above, light input region 140 is solid and substantially cylindrical in shape. However, in the example shown, the side surface 142 of light input region 140 is curved as the result of the light input region having a radius that increases and, hence, cross-sectional area that increases, with increasing distance along axis 133 from light input surface 132. Curved side surface 142 further increases the light coupling efficiency between light source 110 and light guide 130, as will be described next.

Light that exits solid-state light emitter 112 is refracted as it enters the light input region 140 of light guide 130 to an angle of refraction that depends on the angle of incidence on light input surface 132 and the refractive index difference between the coupling material between the solid-state light emitter and the light input surface 132.

Thus, the light enters light input region 140 with angles of refraction relative to light input surface 132 ranging from almost +90° to almost −90°. The extremes of the range are closer to ±90° when the refractive index of the light guide is close to that of the coupling material. When the refractive index of light guide 130 is significantly more than that of the coupling material (such as in embodiments in which air provides the coupling material), the range of the angles of refraction within the light guide is less than ±90°.

Light that enters the light input region 140 of light guide 130 with larger angles of refraction is incident on the side surface 142 closer to light input surface 132 than light that enters the light input region with smaller angles of refraction. Side surface 142 is angled relative to the incident light such that the angle of incidence on the side surface is greater than the critical angle at all locations along the length (axial direction) of the light input region. This confines all of the light received from light source 110 to the light guide. Side surface 142 having the curved shape shown maintains this condition for any angle of refraction at which light enters the cornuate light guide. In an embodiment in which the side surface 142 of light input region 140 is parallel to axis 133, the light entering the light guide with larger angles of refraction is incident on the side surface 142 at angles of incidence less than the critical angle and escapes the light guide through the side surface. In most cases, this is undesirable as it reduces the light coupling efficiency between light source 110 and light output region 160. A higher refractive index material for light guide 130 allows the radius of curvature of side surface 142 to be increased and/or the diameter of light input region 140 to be reduced. In some examples, a light input region 140 having a straight side surface 142 that is non-parallel to axis 133 provides an acceptable coupling efficiency. In other examples, the shape of side surface 142 is designed using suitable ray-tracing software to optimize coupling efficiency. Such designs typically have a radius of curvature that varies with axial distance from light input surface 132.

Referring additionally to FIG. 2, cornuate light guide 130 transitions seamlessly from light input region 140 to flared region 150. Flared region 150 is configured as a flared hollow body that extends substantially axially adjacent light input region 140, as shown in FIG. 3, that extends substantially radially adjacent light output region 160, and that otherwise extends both axially and radially. Flared region 150 surrounds an internal volume 152. The flared region 150 of light guide 130 redirects the light received by the light input region 140 from an axial direction to a radial direction for input to light output region 160. Flared region 150 can be configured to provide a small light output surface (not shown) at the apex 138 of inner major surface 134. Such light output surface is oriented parallel to light input surface 132 to direct light from light input region 140 onto a sensor (described above) located in internal volume 152.

In an embodiment, the way in which curved region 150 flares is defined by a single radius of curvature and the thickness of light guide 130 in the curved region, i.e., the distance between inner major surface 134 and outer major surface 136 measured orthogonally to a tangent to one of the major surfaces, is substantially constant. The relationship between the radius of curvature and the thickness of light guide 130 in flared region 150 is such that light propagates through the flared region by total internal reflection at major surfaces 134, 136 and the intensity of any light output from the flared region of light guide 130 is minimal. In other examples, the way in which curved region 150 flares is defined by different radii of curvature at respective axial distances from light input surface 132 and, additionally or alternatively, the thickness of light guide 130 in curved region 150 changes steplessly with axial distance from light input surface 132. In such examples, the relationship between radius of curvature and thickness at all points along flared region 150 between light input region 140 and light output region 160 is such that light propagates through the flared region by total internal reflection at major surfaces 134, 136 and the intensity of any light output from the flared region of light guide 130 is minimal.

In yet other examples, the relationship between radius of curvature and thickness (a single radius of curvature or multiple radii of curvature and/or one or more thicknesses) in flared region 150 of light guide 130 between light input region 140 and light output region 160 is such that a defined fraction of the light input to light guide 130 at light input surface 132 is extracted from the flared region 150 of light guide 130 through inner major surface 134. Light extraction results from reducing the thickness of the light guide and/or decreasing the radius of curvature of the flared region compared with values that guide the light through the flared region without extraction. In embodiments in which light output from the outer major surface 136 of light guide 130 is not desired, a reflective surface (not shown) is located adjacent the outer major surface 136 of light guide 130 in flared region 150 to reflect light that exits the light guide through the outer major surface back through the light guide so that the light exits the light guide through inner major surface 134. The reflective surface may be provided by a reflective coating applied to outer major surface 136 in flared region 150. Alternatively, the reflective surface may be the surface of an independent component (not shown) mechanically coupled to light guide 130.

In yet other examples, light guide 130 has light-extracting optical elements (not shown) in, on or under at least part of one or both of major surfaces 134, 136 in the flared region 150 of light guide 130 to extract light from the flared region through inner major surface 134. In some embodiments, the light-extracting optical elements have well-defined shapes configured to impart defined directional properties on the tight extracted through inner major surface 134. Again, in embodiments in which light output from the outer major surface 136 of light guide 130 is not desired, a reflective surface (not shown) similar to that just described is located adjacent the outer major surface 136 of light guide 130.

The flared region 150 of light guide 130 transitions seamlessly into the radial light output region 160 of the light guide. Radial light output region 160 is generally planar and extends radially outwards to outer edge 162. The light input, to light output region 160 by flared region 150 propagates radially outward within light output region 160 by total internal reflection at inner major surface 134 and outer major surface 136. In some examples, light output region 160 has a thickness that remains substantially constant with increasing radial distance from axis 133. In other examples, light output region 160 progressively decreases in thickness with increasing radial distance from axis 133. In the example shown in FIG. 2, the thickness is reduced in concentric, circular steps that are radially offset from one another. Each step defines a circumferential facet 164 that extends substantially axially towards light input surface 132. The outer edge 162 of light output region provides an additional facet 164. In an example, each facet reduces the thickness of the light output region 160 of light guide 130 by approximately 25%. In another example, the facets are dimensioned in the axial direction to reduce the thickness of the light output region 160 of light guide 130 by respective percentages that distribute the light propagating radially in light output region 160 substantially equally among light extracting and redirecting members 180-183.

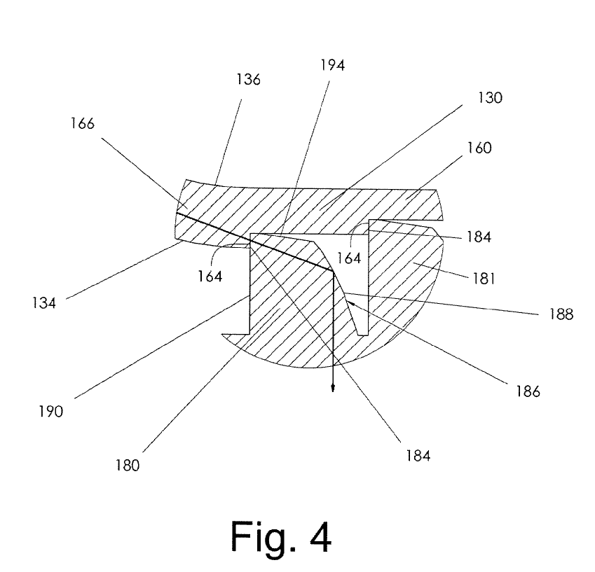

FIG. 4 is an enlarged cross-sectional view showing part of the light output region 160 of light guide 130 and two adjacent light extracting and redirecting members 180, 181. Light extracting and redirecting member 180 will be described next. Light extracting and redirecting members 181-183 are similar and will not be individually described. A circumferential step in the inner major surface 134 of light output region 160 provides circumferential facet 164 that defines the annular region of major surface 134 in optical contact with the light extracting element 184 of annular tight extracting and redirecting member 180. Optical contact between the light extracting element 184 of each light extracting and redirecting member 180-183 and its respective circumferential facet 164 extracts light from light guide 130 into the respective light extracting and redirecting member,

In the example shown, circumferential facet 164 extends axially towards light input surface 132 (FIG. 2). In other examples (not shown), each circumferential facet extends slightly radially outwards in addition to extending axially towards light input surface 132 to promote physical contact between facet 164 and light extracting element 184. Light extracting element 184 is provided by part of a surface 190 of light extracting and redirecting member 180 opposite light redirecting element 186.

Annular reflective light redirecting element 186 is provided by a reflective surface 188 of light extracting and redirecting member 180 opposite light extracting element 184. The material of light extracting and redirecting member 180 mechanically and optically couples light extracting element 184 and light redirecting element 186. Light propagates from light extracting element 184 to light redirecting element 186 and from light redirecting element 186 to light output surface 192 through the material of light extracting and redirecting member 180. Redirecting the extracted light in the material of the light extracting and redirecting member enables the size of light redirecting element 186 to be substantially reduced compared with redirecting the extracted light in air because the cone angle of the light exiting through facet 164 is smaller in light extracting and redirecting member 180 than in air.

The reflective surface 188 that provides light redirecting element 186 is configured to reflect the light extracted by light extracting element 184 by total internal reflection. Moreover, a surface at which total internal reflection occurs requires no additional processing (such as application of a reflective layer) to make it reflective, and the reflectivity of a surface at which total internal reflection occurs is typically greater than that of a reflective layer. In other examples, reflective surface 188 is configured such that the angle of incidence on the reflective surface is less than the critical angle. In this case, a reflective layer is applied to the surface 188 of light extracting and redirecting member 180 opposite light extracting element 184 to make surface 188 reflective. The configuration of reflective surface 188 enables light redirecting element 186 to redirect the light extracted from light guide 130 in a generally axial direction, i.e., in a direction generally parallel to longitudinal axis 133, and with a defined light ray angle distribution suitable for a particular application. The light redirected by light redirecting member 186 exits light extracting and redirecting member 180 through a light output surface 192 (FIG. 2) oriented substantially orthogonally to the redirected light. Such an orientation of light output surface 192 reduces Fresnel reflection losses.

Light extracting and redirecting member 180 additionally has a surface 194 opposite surface 192 through which light exits the light extracting and redirecting member. Surface 194 extends from surface 190 in a direction that is radially outwards and that diverges with increasing radial distance from the portion of the inner major surface 134 of light guide 130 opposite surface 194. The non-parallel relationship between surface 194 and inner major surface 134 optically isolates light extracting and redirecting member 180 from the light output region 160 of light guide 130 and ensures that light extracting and redirecting member 180 extracts light from the light guide principally through circumferential facet 164.

The shape of reflective surface 188 determines the directional properties of the light output by lighting assembly 100. In an example, reflective surface 188 has a nominally parabolic shape to create a parallel output light beam having a light ray angle distribution with narrow peak at an angle in a range of angles about the axial direction, but that is typically in the axial direction. In another example, reflective surface 188 has a nominally elliptical shape that produces an output light beam having a light ray angle distribution having a broader peak at an angle in a range of angles abort the axial direction. Reflective surface 188 designed using ray tracing software to produce a defined light ray angle distribution may deviate from the parabolic and elliptical shapes just described.

Facet 164 defines the axial extent of the light extracted from light guide 130. The smaller the axial dimension of facet 164 is relative to the axial dimension of light redirecting element 186, the more closely the source of light for light redirecting element 186 resembles a point source, and the more accurately can the light ray angle distribution of the light redirected by light redirecting element 186 be controlled. In an example, the axial dimension of the facet is one-fifth of the axial dimension of the light redirecting element. In another example, the axial dimension of the facet is one-tenth of the axial dimension of the light redirecting element. In another example, the axial dimension of the facet is one-twentieth of the axial dimension of the light redirecting element.

The example of lighting assembly 180 shown in FIGS. 1 and 2 includes additional annular light extracting and redirecting members 181, 182, 183 each having a respective light extracting element 184 and a reflective light redirecting element 186. The light extracting element 184 of each additional light extracting and redirecting member 181-183 is optically coupled to a respective circumferential facet 164. In the example shown, the respective light redirecting elements 184 of additional light extracting and redirecting members 181-183 have the same shape as the light redirecting element of light extracting and redirecting member 180. In other examples, the light redirecting elements of light extracting and redirecting members 180-184 differ from one another in shape to provide output light having a defined overall light ray angle distribution suitable for a given application.

In the example shown, a linking member 196 (FIG. 2) mechanically couples light extracting and redirecting members 180-183 together. Such coupling can make light extracting and redirecting members 180-183 easier to manufacture and to assemble with light guide 130. Alternatively, light extracting and redirecting members 180-183 can be independent of one another and can be individually affixed to light guide 130.

In an example, light extracting and redirecting members 180-183 are solid articles individually or collectively made by molding or another suitable process from a suitable optically-transparent material such as glass or a plastic, such as polycarbonate or acrylic. Light loss at the interface between each facet 164 and the light extracting element 184 of the respective light extracting and redirecting member 180 is reduced by making the light extracting and redirecting members of the same material as light guide 130, or of a material having a similar refractive index to the light guide. To promote optical coupling between each facet 164 and the light extracting element 184 of the respective light extracting and redirecting member 180, the light extracting element of the light extracting and redirecting member is attached to the light guide using a suitable index-matched optical adhesive, or, if the light extracting and redirecting member and the light guide differ in refractive index, an optical adhesive having a refractive index intermediate between those of the materials of the light extracting and redirecting member and the light guide. Typically, the optical adhesive is applied sparingly to the facet 164. Other techniques for optically coupling optical components are known in the art and may be used.

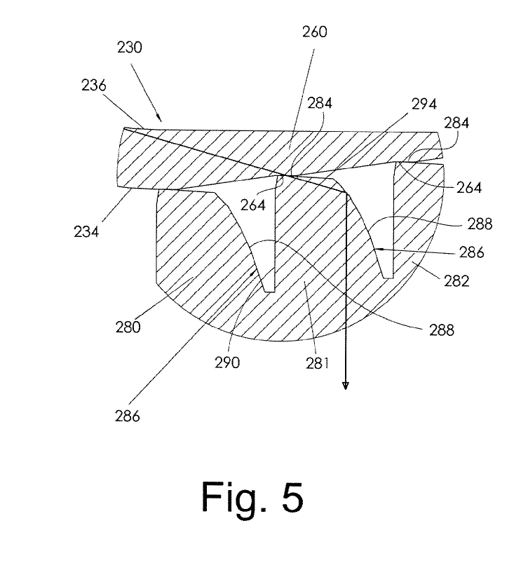

FIG. 5 is an enlarged cross-sectional view showing part of the light output region 260 of a cornuate light guide 230 and light extracting and redirecting member 281 of another embodiment of a lighting assembly 200. Also shown are parts of adjacent light extracting and redirecting members 280, 282 that are similar to light extracting and redirecting member 281 and so will not be individually described. Reference numeral 281 is additionally used to refer to the light extracting and redirecting members in general. Since lighting assembly 200 is similar to lighting assembly 100 described above with reference to FIGS. 1-4, only the differences will be described. Corresponding elements in lighting assembly 200 are indicated by the same reference numerals increased by 100.

In the example shown, the thickness of light output region 260 of light guide 230 decreases linearly between the connecting region (not shown, but see 150 in FIG. 2) of the light guide and the outer edge (not shown, but see 162 in FIG. 2). The linear taper of the thickness of the light output region is interrupted at intervals by circumferential facets 264 that extend substantially radially, in contrast to the axially-extending facets 164 shown in FIG. 4. Annular light extracting and redirecting member 281 has an annular light extracting element 284 and an annular reflective light redirecting element 286. Light extracting element 284 of light extracting and redirecting member 281 is in contact with a respective circumferential facet 264 of the light output region 260 of light guide 230 to extract light from the light output region 260. Light extracting and redirecting members 281 differ from light extracting and redirecting members 180 in that light extracting element 284 is part of surface 294 adjacent reflective surface 288 and opposite the surface corresponding to surface 192 shown in FIG. 2 from which light exits light extracting and redirecting member 281. The remainder of surface 294 outside light extracting element 284 extends radially non-parallel to the inner major surface 234 of the light output region 260 of light guide 230 to optically isolate light extracting and redirecting member 281 from light guide 230 except where light extracting element 284 is in optical contact with radial circumferential facet 264.

As noted above, annular reflective light redirecting element 286 is located adjacent the surface 194 part of which provides light extracting element 284. Light redirecting element 286 is provided by a reflective surface 288 of light extracting and redirecting member 281. The reflective surface 288 that provides light redirecting element 286 is configured to reflect the light extracted by light extracting element 284 by total internal reflection. Possible shapes of reflective surface 288 are similar to those described above for reflective surface 188 and will not be described again here. The advantages of redirection by a surface at which total internal refection occurs are described above with reference to reflective surface 188. In other examples, reflective surface 288 is configured such that the angle of incidence on the reflective surface is less than the critical angle. In this case, a reflective layer (not shown) is applied to the surface 288 of light extracting and redirecting member 281 adjacent light extracting element 284 to make surface 288 reflective. The configuration of reflective surface 288 enables light redirecting element 286 to redirect the light extracted from light guide 230 in a generally axial direction, i.e., in a direction generally parallel to longitudinal axis 133, and with a defined light ray angle distribution suitable for a particular application. The light redirected by light redirecting member 286 exits light extracting and redirecting member 281 through a light output surface that corresponds to light output surface 192 described above with reference to FIGS. 1-4.

The accuracy with which light redirecting element 286 redirects the light extracted by light extracting elements 284 into a light beam having a defined light ray angle distribution depends in part of the ratio between the radial size of light extracting element 284 and the axial size of light redirecting element 286.

Similar to lighting assembly 100 described above with reference to FIGS. 1 and 2, lighting assembly 200 additionally has a light extracting and redirecting member at the outer edge (not shown) of the light output region 260 of light guide 230. The outer edge of light output region 260 is generally axially oriented similarly to the outer edge 162 of the light output region 160 of light guide 130 shown in FIG. 2. Consequently, the light extracting and redirecting member at the outer edge (not shown) of the light output region 260 of light guide 230 is similar in structure and operation to light extracting and redirecting member 180 described above with reference to FIGS. 1-4. The light extracting and redirecting member at the outer edge differs in structure from light extracting and redirecting members 281.

In another embodiment (not shown) of lighting assembly 200, the taper of e light output region 260 of light guide 230 is uninterrupted by facets similar to radial circumferential facets 264. In such an embodiment, light extracting element 284 is sloped to match the slope of inner major surface 234 resulting from the linear reduction in the thickness of light output region 260. Alternatively, the thickness of light output region 2.60 may be linearly reduced with increasing radial distance by sloping outer major surface 236 in light output region 260. In this case, inner major surface 234 extends orthogonally to axis 133 (FIG. 2).

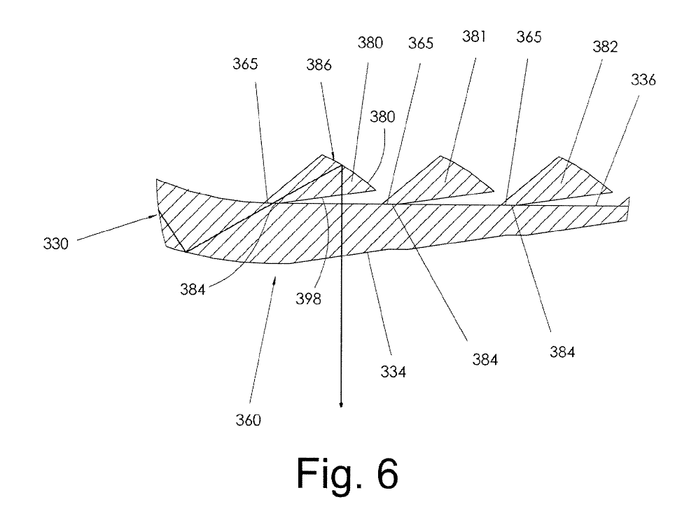

FIG. 6 is an enlarged cross-sectional view showing part of the light output region 360 of a light guide 330 and three adjacent light extracting and redirecting members 380, 381, 382 of yet another embodiment of a lighting assembly 300. Reference numeral 380 is additionally used to refer to the light extracting and redirecting members in general. Since lighting assembly 300 is similar to lighting assembly 100 described above with reference to FIGS. 1-4, only the differences will be described. Corresponding elements in lighting assembly 300 are indicated by the same reference numerals increased by 200.

In lighting assembly 300, the inner major surface 334 of the light output region 360 of light guide 330 is sloped to linearly reduce the thickness of the light output region with increasing radial distance from longitudinal axis 133 (FIG. 2) and outer major surface 336 extends radially. Light extracting and redirecting members 380 are configured to extract light from the light output region 360 of light guide 330 through outer major surface 336 and to redirect the extracted light back through the light output region of the light guide and out through the inner major surface 334 of the light guide.

Annular light extracting and redirecting member 380 will now be described. Light extracting and redirecting members 381 and 382 are similar and will not be individually described. Annular light extracting and redirecting member 380 has a roughly triangular cross-sectional shape in a plane parallel to longitudinal axis 133. The light extracting and redirecting member has a light extracting element 384 in optical contact with an annular region 365 of the outer major surface 336 of light guide 330. The light extracting and redirecting member additionally has an annular reflective light redirecting element 386 opposite light extracting element 384 to axially redirect the light extracted by the light extracting element 384 back through the light output region 360 of light guide 330.

Light extracting element 384 is part of one surface 398 of the triangular cross-section of light extracting and redirecting member 380. Light extracting element 384 is oriented to form an optical contact with the annular region 365 of outer major surface 336. The remainder of surface 398 extends radially non-parallel to the outer major surface 336 of the light output region 360 of light guide 330 to optically isolate light extracting and redirecting member 380 from light guide 330 except where light extracting element 384 is in optical contact with annular region 365.

Annular reflective light redirecting element 386 is located opposite light extracting element 384. Light redirecting element 386 is provided by a reflective surface 388 of light extracting and redirecting member 380. The reflective surface 388 that provides light redirecting element 386 is configured to reflect the light extracted by light extracting element 384 by total internal reflection. Possible shapes of reflective surface 388 are similar to those of reflective surface 188 described above with reference to FIG. 4 and will not be described again here. The advantages of redirection by a surface at which total internal refection occurs are described above with reference to reflective surface 188. In other examples, reflective surface 388 is configured such that the angle of incidence on the reflective surface is less than the critical angle. In this case, a reflective layer (not shown) is applied to the surface 388 of light extracting and redirecting member 380 opposite light extracting element 384 to make surface 388 reflective. The configuration of reflective surface 388 enables light redirecting element 386 to redirect the light extracted from light guide 330 in a generally axial direction, i.e., in a direction generally parallel to longitudinal axis 133 (FIG. 2), and with a defined light ray angle distribution suitable for a particular application. The light redirected by light redirecting member 386 exits light extracting and redirecting member 280 through surface 398, passes back through the light output region 360 of light guide 300 and exits the light guide through inner major surface 334. The light from light extracting and redirecting member 380 is incident on the major surfaces 334, 336 of light guide 330 at angles of incidence close to zero, so little refraction takes place as the light passes back through the light guide, and Fresnel reflection losses are minimized.

The accuracy with which light redirecting element 386 redirects the light extracted by light extracting element 384 into a light beam having a defined light ray angle distribution depends in part of the ratio between the radial size of light extracting element 384 and the axial size of light redirecting element 386.

Similar to lighting assembly 100 described above with reference to FIGS. 1 and 2, lighting assembly 300 additionally has a light extracting and redirecting member at the outer edge (not shown) of the light output region 360 of light guide 330. The outer edge of light output region 360 is generally axially oriented similarly to the outer edge 162 of the light output region 160 of light guide 130 shown in FIG. 2. Consequently, the light extracting and redirecting member at the outer edge (not shown) of the light output region 360 of light guide 330 is similar in structure and operation to light extracting and redirecting member 180 described above with reference to FIGS. 1-4. The light extracting and redirecting member at the outer edge differs in structure from light extracting and redirecting members 380-382. Moreover, light redirected by the light extracting and redirecting member at the outer edge of the light guide 330 does not pass back through light guide.

In another embodiment (not shown) of lighting assembly 300, the outer major surface 336 of light guide 330 is sloped to reduce the thickness of the light output region 360 of light guide 330 with increasing radial distance from longitudinal axis 133. In such an embodiment, light extracting element 364 is sloped similarly to outer major surface to provide optical contact between the light extracting element and major surface 336. In yet another embodiment, the outer major surface 336 of light guide 330 is sloped to reduce the thickness of the light output region 360 of light guide 330 with increasing radial distance from longitudinal axis 133, and the slope of the outer major surface is interrupted by circumferential facets that extend radially similar to radial circumferential facets 264 described above with reference to FIG. 5. In such an embodiment, light extracting element 364 extends radially to provide optical contact with the radially-extending facets in the outer major surface 336 of light guide 330.

In the above disclosure, light extracting and redirecting members 180, 280, 380 are described as being annular. However, in other embodiments, light extracting and redirecting members 180, 280, 380 are composed of arcuate segments arranged to form the annular shape described. In yet other examples, light extracting and redirecting members 180, 280, 380 are composed of linear segments arranged along respective sides of a polygon, such as a regular polygon, to approximate the annular shape described. Typically, no light is extracted from the light output portion of the light guide in gaps between the segments.

A light bulb may be formed by affixing a lighting assembly such as lighting assemblies 100, 200, 300 to a base (not shown) configured to mechanically mount the light bulb and receive electrical power. A power converter mounted in or adjacent the base converts AC power to low-voltage DC power suitable to power light source 110. References herein to a “light bulb” are meant to broadly encompass light-producing devices that fit into and engage any of various fixtures for mechanically mounting the light-producing device and for providing electrical power thereto. Examples of such fixtures include, without limitation, screw-in fixtures for engaging an Edison light bulb base, a bayonet fixture for engaging a bayonet light bulb base, or a bi-pin fixture for engaging a bi-pin light bulb base. Thus the term “light bulb,” by itself, does not provide any limitation on the shape of the light-producing device, or the mechanism by which light is produced from electric power. Also, the light bulb need not have an enclosed envelope forming an environment for light generation. The light bulb may conform to American National Standards Institute (ANSI) or other standards for electric lamps, but the light bulb does not necessarily have to have this conformance.

Embodiments of lighting assembly 100 in which the light output by each light extracting and redirecting member has a narrow light ray angle distribution may illuminate a target surface with an illumination profile having a central region of low intensity. Light extracted through the inner major surface of the flared region 150 of light guide 130 as described above may be used to illuminate the central region. However, the light ray angle distribution of such extracted light may differ from that of the light output by light extracting and redirecting members 180 so that the extracted light may illuminate the central region only when the target surface is at a defined distance from the lighting assembly. This restriction may be undesirable in some applications.

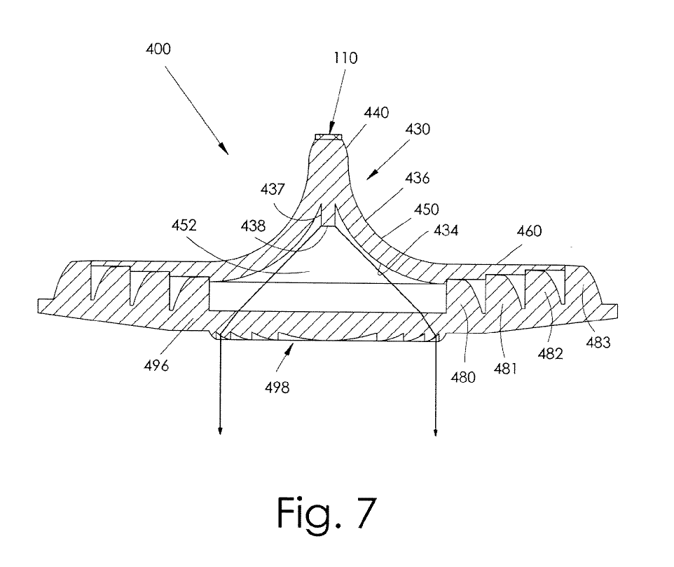

FIG. 7 is a cross-sectional view of another embodiment 400 of a lighting assembly that provides light for illuminating the central region with a light ray angle distribution similar to that of the light output by light extracting and redirecting members 180. Elements of lighting assembly 400 corresponding to those of lighting assembly 100 described above with reference to FIGS. 1-4 are indicated using the same reference numerals and will not be described again in detail. The illumination profiles produced by lighting assemblies 200 and 300 described above with reference to FIGS. 5 and 6 have a similar central region and these lighting assemblies may be similarly modified.

Lighting assembly 400 has a cornuate light guide 430 similar in configuration to cornuate light guide 130 described above with reference to FIGS. 1-4. Cornuate light guide 430 differs from cornuate light guide 130 in that inner major surface 434 does not define a sharp apex similar to apex 138. Instead, the light input region 440 of light guide 430 includes an elongate auxiliary light guide 437 that extends axially within the internal volume 452 of the flared region 450 of the light guide. The inner major surface 434 of light guide 430 in flared region 450 extends axially and radially from the proximal end of auxiliary light guide 437. Auxiliary light guide 437 has a light output surface 438 at its distal end remote from light input region 440. Light output surface 438 is disposed nominally parallel to light input surface 432. A portion of the light input to light guide 430 at light input surface 432 passes axially through light input region 440 and auxiliary light guide 437, and exits through light output surface 438.

Lighting assembly 400 additionally includes a light redirecting member 498 offset axially from light output surface 438 of auxiliary light guide 437 to redirect the light output through the light output surface. In the example shown, light redirecting member 498 is integral with linking member 496 that links light extracting and redirecting members 480-483. Specifically, light redirecting member 498 is located on a major surface of linking member 496 remote from light source 110. In other examples, light redirecting member 498 is independent of linking member and is mechanically linked to light guide 430 and/or one or more of light extracting and redirecting members 480-483 by another structure (not shown). Light redirecting member 498 has a radial size slightly smaller than the innermost light extracting and redirecting member 480.

Light output surface 438 has a diverging characteristic to spread the light exiting light guide 430 through the light output surface radially such that the light is incident on at least a majority of the area of light redirecting member 498. In various examples, the light output surface includes one or more refractive or diffractive elements to provide the diverging characteristic. In an example, light output surface includes concentric lenticular grooves, a lenslet array or a pattern of microlenses (none of which is shown) to provide the diverging characteristic.

Light redirecting member 498 has a converging characteristic to reduce the spread. of the light incident thereon from light output surface 438 to produce an output light beam having a defined light ray angle distribution. In an example, the light ray angle distribution of the light beam output by light redirecting member 498 is similar to that of the light output by light extracting and redirecting members 480-483. The light output by the light redirecting member provides light to the central region of low intensity in the illumination profile produced by the light output by the light extracting and redirecting members. In various examples, light redirecting member includes one or more refractive or diffractive elements to provide its converging characteristic. In an example, light output surface includes a Fresnel lens to provide the converging characteristic.

The proximal end of auxiliary light guide 437 has a radial size configured such that the light that exits the light guide 430 through the auxiliary light guide produces an illuminance at the target surface similar to that of the light output by the light extracting and redirecting members after passing through the light redirecting member.

In this disclosure, the phrase “one of” followed by a list is intended to mean the elements of the list in the alterative. For example, “one of A, B and C” means A or B or C. The phrase “at least one of” followed by a list is intended to mean one or more of the elements of the list in the alterative. For example, “at least one of A, B and C” means A or B or C or (A and B) or (A and C) or (B and C) or (A and B and C).

1. A lighting assembly, comprising:
a light source;
a cornuate light guide, comprising:
a radial light input edge adjacent the light source,
a light input region extending axially from the light input surface,
a radial light output region comprising an outer edge,
a flared region coupling the light input region to the light output region, and
an inner major surface and an outer major surface, where light input to the light guide through the light input surface propagates to and within the light output region by total internal reflection at the major surfaces; and
an annular light extracting and redirecting member, comprising:
a light extracting element in optical contact with an annular region of one of the major surfaces of the light output region of the light guide, and
a reflective light redirecting element to axially redirect the light extracted by the light extracting element with a defined light ray angle distribution.

2. The lighting assembly of claim 1 in which the light output region of the light guide decreases in thickness with increasing radial distance.

3. The lighting assembly of claim 1, in which the light input region comprises at least a portion that increases in radial cross-sectional area with increasing distance from the light input surface.

4. The lighting assembly of claim 1, in which the light source comprises a solid-state light emitter in optical contact with the light input surface.

5. The lighting assembly of claim 1, in which:
the light source comprises solid-state light emitters in optical contact with the light input surface; and
the solid-state light emitters generate different colors of light.

6. The lighting assembly of claim 1, in which:
the one of the major surfaces of the light guide comprises an annular facet that provides the annular region; and
the light extracting element of the light extracting and redirecting member comprises a surface in optical contact with the facet to extract light from the light guide.

7. The lighting assembly of claim 6, in which the facet is small in size compared with the light redirecting element of the light extracting and redirecting member.

8. The lighting assembly of claim 6, in which the light extracting and redirecting member is isolated from the light guide except at the facet.

9. The lighting assembly of claim 6 in which the inner major surface of the light output region of the light guide comprises the facet, and the facet extends axially.

10. The lighting assembly of claim 6, in which the inner major surface of the light output region of the light guide comprises the facet, and the facet extends radially.

11. The lighting assembly of claim 6, in which:
the outer major surface of the light output region of the light guide comprises the facet, and the facet extends radially; and
the light redirecting element reflects the light extracted by the light extracting element back through the light output region of the light guide.

12. The lighting assembly of claim 1, in which:
the annular region is an annular region of the outer major surface of the light guide; and
the light redirecting element reflects the light extracted by the light extracting element back through the light output region of the light guide.

13. The lighting assembly of claim 1, additionally comprising at least one additional annular light extracting and redirecting member, each additional annular light extracting and redirecting member comprising:
a respective light extracting element in optical contact with a respective annular region of the one of the major surfaces of the light output region of the light guide; and
a respective light redirecting element to axially redirect the light extracted from the light guide by the additional light redirecting element.

14. The lighting assembly of claim 13, in which:
the one of the major surfaces of the light guide comprises a respective annular facet that provides each annular region of the one of the major surfaces of the light guide; and
the light extracting element of each light extracting and redirecting member comprises a surface in optical contact with the respective facet to extract the light from the light guide.

15. The lighting assembly of claim 14, in which each facet is small in size compared with the light redirecting element of the respective light extracting and redirecting member.

16. The lighting assembly of claim 14, in which each light extracting and redirecting member is optically isolated from the light guide except at the respective facet.

17. The lighting assembly of claim 14, in which the inner major surface of the light output region of the light guide comprises the facets, and each facet extends axially.

18. The lighting assembly of claim 14, in which the inner major surface of the light output region of the light guide comprises the facets, and each facet extends radially.

19. The lighting assembly of claim 14, in which:
the outer major surface of the light output region of the light guide comprises the facets, and each facet extends radially; and
in each light extracting and redirecting member, the respective light redirecting element reflects the light extracted by the respective light extracting element back through the light output region of the light guide.

20. The lighting assembly of claim 13, in which:
each annular region is a respective annular region of the outer major surface of the light guide; and
the respective light redirecting element of each light extracting and redirecting member reflects the light extracted by the respective light extracting element back through the light output region of the light guide.

21. The lighting assembly of claim 1, in which the light extracting and redirecting member comprises arcuate segments.

22. The lighting assembly of claim 1, in which the light extracting and redirecting member comprises linear segments arranged along respective sides of a polygon.

23. The lighting assembly of claim 1, in which the flared region of the light guide has a curvature and a thickness configured to extract a portion of the light from the light guide through inner major surface of the flared region.

24. The lighting assembly of claim 1, in which:
the light guide additionally comprises an elongate auxiliary light guide extending axially from the light input region of the light guide to a diverging light output surface; and
a converging light redirecting element located to receive the light from the light output surface and to direct the light axially.

25. A light bulb, comprising a lighting assembly in accordance with claim 1.
